(19) United States
(12) Patent Application Publication
(10) Pub. No.: US 2008/0278120 A1
(43) Pub. Date: Nov. 13, 2008

(54) GENERATOR CONTROL SYSTEM AND METHOD AND VEHICLE INCLUDING SAME

(76) Inventor: Kazuo Sato, Shizuoka-ken (JP)

Correspondence Address: Ernest A.Beutler, 10 Rue Marseille, Newport Beach, CA, 92660-8016, US

(21) Appl. No.: 11/876,517

(22) Filed: Oct. 22, 2007

(30) Foreign Application Priority Data
May 11, 2007 (JP) 2007-126409

(51) Int. Cl. H02P 9/00

(52) U.S. Cl. 322/28; 180/219

(57) ABSTRACT

An internal combustion engine, battery and charging system therefore including a generator particularly adapted for use in straddle ridden vehicles and wherein the charging system for the battery and operating electrical accessories of the engine wherein the charging is regulated in response to sensed conditions of the engine operation and the electrical devices therefor.

### BACKGROUND OF THE INVENTION

This invention relates to a prime mover driven generator and specifically the control system and method of controlling it as well as a vehicle employing the controlled generator.

Such generators are frequently employed in vehicles, particularly those wherein the operator of the vehicle rides it in a straddle fashion. The generator is employed to power various electrical devices of the vehicle such as its lights and the ignition system for the powering prime mover, such as an internal combustion engine.

Referring first to FIG. 1, it shows a typical prior art type of vehicle embodying such a generator control for a typical straddle type vehicle, the motorcycle indicated generally by the reference numeral 11. The motorcycle 11 has a frame assembly 12 that rotatably supports front 13 and rear 14 wheels. The front wheel 13 is dirigibly supported by the frame assembly 12 and is steered by a handle bar 15. A rider supported on a seat operates the motorcycle.

The rear wheel is suitably driven through a transmission by a suitable internal combustion engine 16, mounted in the frame assembly 12.

Referring now to the lower portion of FIG. 1, it will be seen that the engine 16 has an output shaft 17 which in addition to driving the wheel 14 drives an electrical generator (magneto) shown schematically and indicated by the reference numeral 18. The output of the generator 18 is conventionally controlled by a control or regulator, indicated generally at 19, for regulating its three phase output and for powering various electrical components of the motorcycle 11.

These electric components, indicated generally by the reference numeral 21 include such things as headlight 21a, brake lamp 21b and other electric devices 21c), and a generated current from a battery 13 provided in parallel with the regulator 19 is supplied to the electric devices 21.

In addition, the regulated output from the generator 19 is connected in parallel with a storage battery 22. The engine 16 is started by a starter motor (not shown but included in the other devices 21c). When the engine 16 is operated at low speed, the regulator 19 controls so that a load is applied to the generator 19 from the low-speed rotation range of the engine 16 and a generated current Ix is controlled to vary in response to variation of a load currently. When the generated current Ix is greater than the load currently, a charging current Iq(=Ix−Iy) is delivered to charge the battery 22. This type of system is generally shown in Japanese Published Application JP-A-2005-237084.

This type of control system has several disadvantages. For example, it provides an insufficient generating control in which an energy-saving operation is not sufficiently achieved. Furthermore, the generated current can not smoothly match the varied load current. When the engine 16 is operated at low speed, for example, a large load torque is applied to the magneto 18 as the generated voltage of the magneto 18 is controlled to generate a large current by the regulator 19 from the low-speed rotation range of the engine 16, while the starter motor receives electricity from the battery 22 to start and rotate the crankshaft 17. In this way, the starter motor can hardly rotate the crankshaft 17, which may cause a start-up failure of the internal combustion engine 16. Further, the generated current Ix can not smoothly correspond to the varied load current Iy and may stop to feed the generated current Ix.

It is, therefore, a principal object of the invention to provide an improved generator control system for a vehicle that more effectively control the generated power output relative to the required electrical load even though the load may vary significantly.

### SUMMARY OF THE INVENTION

This invention is adapted to be embodied in a generator control device that comprises a magneto driven by the crankshaft of an internal combustion engine for generating an AC current This includes a generated current control for rectifying the AC current to a DC current and regulating the amount of generated power to supply the regulated generated current to an electric device. A battery is connected to the electric device in parallel with the generated current control. The generated current control includes a rectifying section for converting the AC current generated by the magneto to a DC current and a regulating section for regulating the amount of generated power of the rectifying section The magneto is of a three-phase magnet type and the rectifying section is constructed by three series-connected sets of a diode and a thyristor configured in a three-phase bridging connection. The AC current induced by each stator coil of the magneto is inputted at a mid point of the diode and the thyristor. The regulating section includes a nonvolatile memory which stores phase data used for an output timing for a trigger signal outputted to a gate of the thyristor corresponding to each operation mode as determined from the rotational speed and acceleration of the driving internal combustion engine. This calculates the rotational speed and the acceleration based on a signal related to a rotation period of one of the crankshaft and the magneto to determine the operation mode. Then it retrieves the phase data corresponding to the operation mode, and outputs the trigger signal to the gate of each thyristor based on the phase data.

### BRIEF DESCRIPTION OF THE DRAWINGS

FIG. 1 is a perspective view of a motorcycle having an electrical system, as shown in the encircled area view, that is constructed and operated in accordance with the prior art.

FIG. 2 is a diagram, in part similar to that shown in the circuit diagram portion of FIG. 1, but constructed and operated in accordance with the invention.

FIG. 3 is a time diagram showing the voltage control signals and generated currents resulting from the invention.

FIG. 4 is a diagrammatic view showing the control routine embodying the invention.

FIG. 5 is a diagrammatic view showing one way of determining the state as performed in the Step S13 of FIG. 4.

FIG. 6 is a diagrammatic view showing another way of determining the state as performed in the Step S13 of FIG. 4.

### DETAILED DESCRIPTION

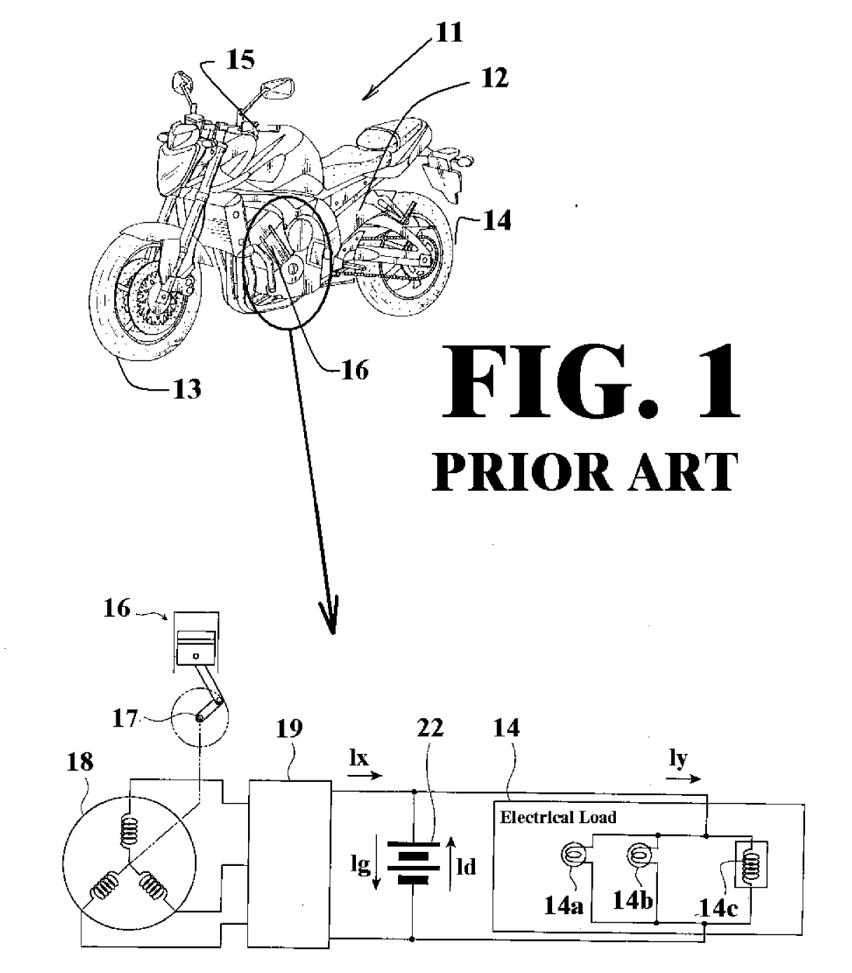

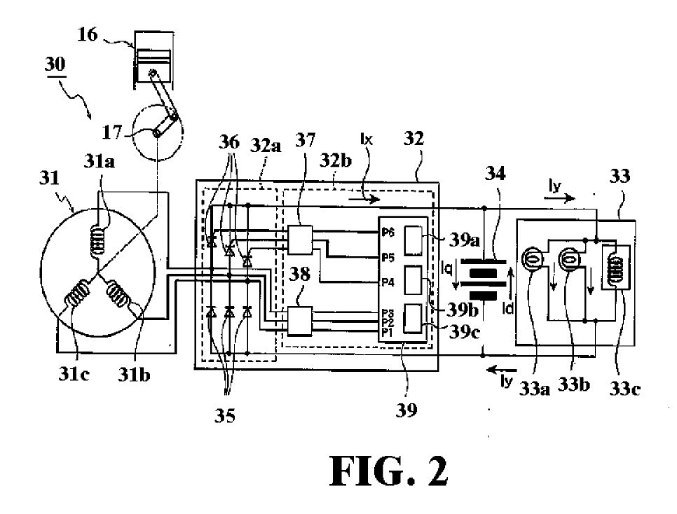

Referring first to FIG. 2, this is a view similar to the lower portion of FIG. 1, but shows schematically a generator control device constructed and operated in a manner embodying the invention. Although not so limited, this system and its method of operation may be employed with a straddle type vehicle such as the motorcycle is shown in FIG. 1. The generator and its control device is indicated generally by the reference numeral 31

First, the construction will be described. As shown in FIG. 1, a generator and control device, indicated generally at 30, includes a magneto 31 for generating an AC current and driven, like the prior art, from the crankshaft 17 of the engine 16. A generated current control device, indicated generally at 32, is provided for rectifying the AC current to a DC current and regulating the amount of generated power. The regulated amount of current is supplied in parallel to electric devices 33 and a battery 34.

The generator (magneto) 31 is a three-phase AC generator driven by rotation of a crankshaft 17 of the engine (internal combustion engine) 16 in which a permanent magnet (not shown) mounted on a rotor rotates to generate electricity by cooperation with three stator coils 31a, 31b and 33c.

The generated current control 32 includes a circuit section for rectifying the AC current generated by the magneto 31 to a DC current and regulating the amount of generated current and includes a rectifying section 32A and a regulating section 32B.

When a generated current Ix from the generated current control means 32 is smaller than a load current Iy of the electric devices 33, the battery 34 supplies a discharging current Id to the electric devices 33. On the contrary, when the generated current Ix is larger than the load current Iy, a charging current Iq is supplied to the battery 34.

Here, by way of example, the electric devices 33 may include a headlight 33a, a brake lamp 33b, and other electric devices 33c. The other electric devices 33c may include an ignition controller, an engine control unit, an FI controller, a tail lamp, a stop lamp, a neutral indicator, a meter, a motor-driven pump and so forth.

Now, the generated current control means 32 as one major part of the present invention will be described in detail. The rectifying section 32A is a circuit section for rectifying the AC current generated by the magneto 31 to a DC current. The rectifying section 32A is constructed with three series-connected sets each of which comprises an upstream diode 35 and a downstream thyristor 36 are configured in a three-phase bridging connection. The AC current induced by each stator coil or winding 31a to 31c of the magneto 31 is inputted at the mid point of a respective diode 35 and thyristor 36 connection.

The rectifying section 32A is further constructed such that a certain level of current outputted from a trigger signal output circuit 37 (described later) is inputted to each gate of the thyristors 36 to bring the anode and the cathode of the thyristor 36 into a conduction state (turn-on) and to thus output a variable generated current.

In order to cease conduction (turn-off), a current passed between the anode and the cathode needs to be equal to or smaller than a certain value. In this case, when the AC current becomes equal to or smaller than a certain value, the anode and the cathode turn off.

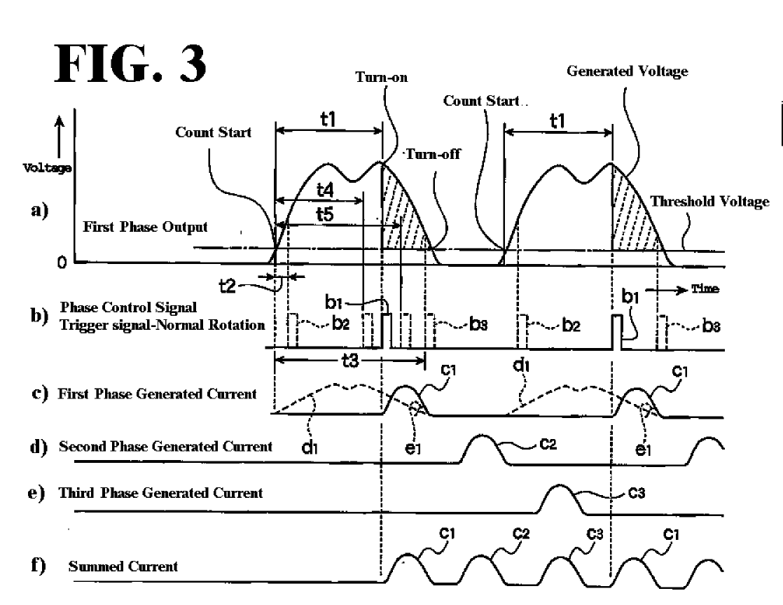

How the amount of generated power is varied by phase control will be described with reference to FIG. 3. A generated voltage curve between the diode 35 and the thyristor 36 in a single phase is shown in curve (a) of a voltage versus time. The phase control always monitors the generated voltage, starts time counting immediately after detecting that the voltage exceeds a threshold level, and outputs a trigger signal b1 after time t1 has elapsed.

When the phase control outputs a phase control signal (trigger signal) b1 at a timing shown in FIG. 3(b), a portion between a turn-on and a turn-off indicated by hatching in FIG. 3(a) corresponding to a current c1 shown in FIG. 3(c) is outputted from the thyristor 36. That is FIG. 3(c) shows a current of one phase while FIGS. 3(d) and 3(e) show currents of the other two phases. Currents in three phases shown in FIGS. 3(c), 3(d) and to 3(e) are summed to form a composed generated current shown in FIG. 3(f) that will be outputted from the rectifying section 32A.

The area indicated by hatching in FIG. 3(a) represents amplitude of the current. In the case that the counted time becomes smaller as indicated by the broken line t2 (timing of the trigger signal shifts to the left), when a trigger signal b2 is outputted, the amount of generated power becomes larger indicated by d1. On the contrary, in the case that the counted time becomes longer as indicated by t3 (timing of the trigger signal shifts to the right), and a trigger signal b3 is outputted, the amount of generated power becomes smaller as indicated by e1. The counted time t1, t2 and t3 are calculated by converting the rate of the phase data with respect to the rotation period into time.

The regulating section 32B includes a voltage detection circuit 38, a microcomputer 39, and the trigger signal output circuit 37.

The voltage detection circuit 38 is constructed so that: inputting a frequency signal from the stator coils 33a to 33c (three phases of the rectifying section 32A) and outputting a voltage in response to the frequency signal for three phases are performed. The voltages of three phases (signal related to rotation period) are respectively inputted to three analog ports P1, P2 and P3 of the microcomputer 39.

The microcomputer 39 stores in a nonvolatile memory ROM 39c phase data used for output timing for the trigger signal outputted to the gate of each thyristor 36 of the rectifying section 32A corresponding to each operation mode determined by the rotational speed and the acceleration of the internal combustion engine. The phase data corresponds to the output time of the trigger signal converted from the time of the rotation period shown in FIG. 3(a).

The phase data stored in the ROM 39c in this embodiment has following relations when converted to the output time of the trigger signal.

(1) In a start-up operation mode, the phase data is set in such a manner that an output instruction signal for the trigger signal b3 in FIG. 3 is outputted at the longest timing t3 or no output instruction signal for the trigger signal is outputted.

(2) In an idling operation mode, the phase data is set in such a manner that the output instruction signal for the trigger signal b2 in FIG. 3 is outputted at the shortest timing t2.

(3) In an accelerating operation mode, the phase data is set in such a manner that the output time of the trigger signal is longer (the amount of generated power is smaller) than that in a constant-speed operation mode to which the current revolution belongs.

(4) In a decelerating operation mode, the phase data is set in such a manner that the output time of the trigger signal is shorter than the current output time so that the amount of generated power is larger than the load current of the electric devices 33 and sufficient to charge the battery 34 thereby preventing the battery from over-discharging.

(5) In an operation mode in which the headlight is lit, the phase data is set in such a manner that the output time of the trigger signal is longer than that in the current operation mode without lighting the headlight so that the amount of generated power is controlled to prevent the battery from over-discharging during a long time operation.

(6) In a high-speed constant operation mode, the output time of the trigger signal is set shorter than that in a middle-speed constant operation mode or in a low-speed constant operation mode. In a middle-speed constant operation mode or in a low-speed constant operation mode, the output time of the trigger signal is controlled such that the phase data is set in such a manner that the amount of generated power is controlled to prevent the battery from over-discharging during a long time operation.

Further, the microcomputer 39 includes a phase angle setting means constituted by software, a count start timing determination means, and a trigger signal output instructing means.

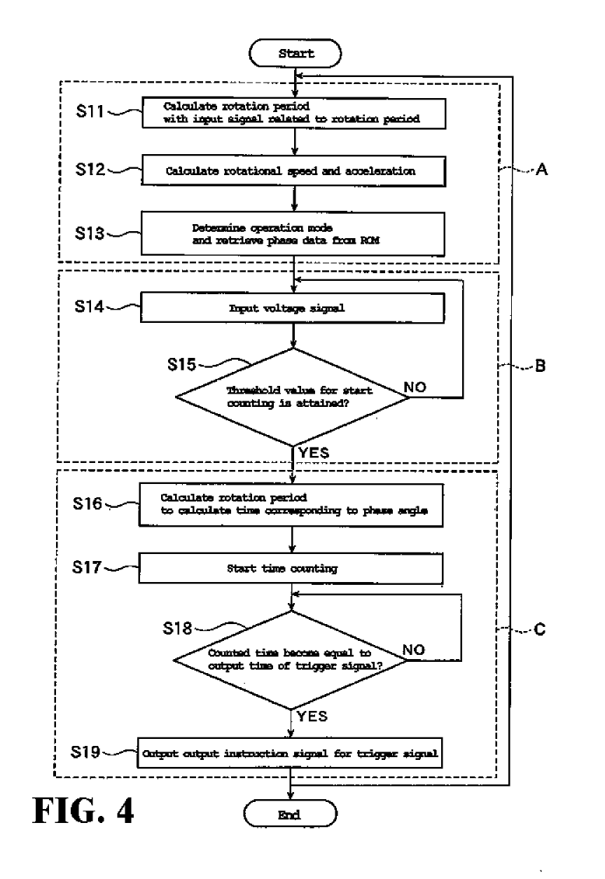

The phase angle setting means, shown as section A in a flowchart of FIG. 4, calculates rotational speed and acceleration with an input signal related to the rotation period of the magneto (or the crankshaft) and determines the operation mode by the rotational speed and the acceleration to set the phase angle for timing control by retrieving the phase data corresponding to the operation mode from the nonvolatile memory.

The count start timing determination means, shown as section B in the flowchart of FIG. 4, determines whether or not the voltage of the voltage signal inputted from the magneto 31 has reached the threshold voltage for starting calculation of the phase angle after retrieving the phase angle for controlling the output timing of the trigger signal from the nonvolatile memory 39c by the phase angle setting means.

The trigger signal output instructing means, shown as section C in the flowchart of FIG. 4, responsively calculates the phase angle after the count start timing determined by the count start timing determination means, determines whether or not the phase angle is equal to the phase angle for controlling the output timing, and output the output instruction signal for the trigger signal when the phase angle is equal to the phase angle for controlling the output timing.

Thus, the microcomputer 39 is constructed so that a CPU 39a reads a program software stored in a nonvolatile memory ROM 39b, calculates rotational speed and acceleration based on a signal related to the rotation period inputted from the analog ports P1, P2, P3 according to control procedures of the program software, determines the operation mode to extract a corresponding specific code, reads the phase data stored in the nonvolatile memory ROM 39c with the specific code, and outputs the output instruction signal for the trigger signal as the phase control signal to the trigger signal output circuit 37 at a required timing.

Determination of the operation mode is made automatically from the rotational speed and the acceleration for each of prescribed modes such as an idling, start-up, low-speed running, middle-speed running, high-speed running, quick acceleration, slow acceleration, quick deceleration, slow deceleration, headlight lighting and so on. A prescribed specific code is automatically provided to each prescribed operation mode.

The phase data stored in the ROM 39c can be read by selectively assigning the specific code to determine the operation mode, while the phase data is stored in the ROM 39c corresponding to the specific code. The phase data is stored in the ROM 39c in such a manner, for example, that the range of the rotational speed and the range of the acceleration are determined for rapid acceleration and rapid deceleration by repeated running tests and the amount of generated power is determined properly in view of energy-saving operation based on the ranges thereby obtaining the amount of generated power for the rotational speed.

The trigger signal output circuit 37 is constructed so that when three output instruction signals for the trigger signal outputted from the microcomputer 39 are inputted, a trigger signal which feeds each gate of the three thyristors 36 to turn on each thyristor 36 is outputted in response to the output instruction signal for the trigger signal.

As a result, when the trigger signal (pulse signal) is inputted to each gate of the three thyristors 36 from the trigger signal output circuit 37, the rectifying section 32A receives the phase control and varies the generated current as required to output.

Referring now to FIG. 4, this is a flowchart illustrating the procedures in which a CPU of the microcomputer 39 reads the software program from the ROM 39b to execute.

After starting, a rotation period signal is inputted to calculate the rotation period (step S11). Here, the rotation period signal is a detected voltage in three phases variably outputted from the voltage detection circuit 38. Each voltage signal inputted into AN ports p1, p2 and p3 is converted to digital in 256 levels of gradation and, for example, the time between peaks of digital values is calculated in order to calculate the rotation period and stored in a register (or may stored in a DRAM, as same hereinafter).

Next, rotational speed and acceleration are calculated at the step S12. Here, based on the digital values obtained in the step S11, the rotational speed is calculated according to the predetermined procedure and then stored in the register. Subsequently, the acceleration is calculated and then stored in the register.

Next, the operation mode is determined to read the phase data from the ROM 39c (step S13). Here, the operation mode is determined based on the rotational speed and the acceleration obtained in the step S12, the specific code (memory address) is provided and the phase data stored in the ROM 39c is retrieved using the specific code.

Next, a sample voltage signal is inputted at the step S14. Here, three sample voltage signals outputted from the voltage detection circuit 38 are inputted into the AN ports p1 to p3 to be converted to digital in 256 levels of gradation and the converted signals are inputted to the register.

Next, it is determined whether or not each voltage signal inputted into the AN ports p1 to p3 has reached a second threshold voltage at which count starts (step S15). Here, the timing at which a detected voltage obtained in the step S14 becomes equal to or greater than the threshold voltage is watched by comparing both voltages. When the detected voltage is smaller, the determination is made “NO” and the step returns to the step S14 in which a new detected voltage is obtained to repeat the determination. When the value of the register becomes equal to or greater than the second threshold voltage, the determination is made “YES” and the program proceeds to the step S16.

In the step S16, the rotation period signal is inputted into the AN ports p1 to p3 to calculate the rotation period and the output time of the trigger signal corresponding to the phase data is calculated. Then, time counting is started at the step S17).

Next, at the step S18, it is determined whether or not the counted time becomes the output time of the trigger signal t. Here, the counted time is compared to the output time of the trigger signal calculated in the step S16 and time counting is kept until the counted time becomes equal to the output time of the trigger signal. When the counted time becomes equal to the output time of the trigger signal, the output instruction signal for the trigger signal is outputted at the step S19.

The output instruction signals for the trigger signal are outputted from three I/O ports p4 to p6 and inputted to the trigger signal output circuit 37. The trigger signal output circuit 37 outputs the trigger signal to the gate of the thyristor 36 in the rectifying section 32A in response to the output instruction signal for the trigger signal. As a result, the thyristor 36 receives the phase control to output the generated current variably so that the engine 16 has an energy-saving operation.

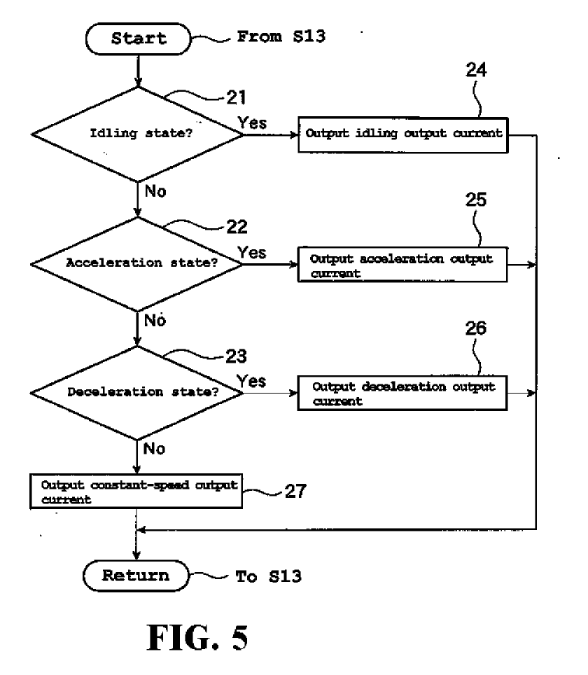

Referring now to FIG. 5, this is a flowchart (subroutine) showing a detailed procedure regarding how the operational mode can be determined at the step S13 of the flowchart in FIG. 4.

According to the method employed in this flowchart, the determinations of whether the operation mode is idling or not (step S21), whether the operation mode is acceleration or not (step S22), and whether the operation mode is deceleration or not (step S23) are sequentially made based on the amplitude of the rotational speed and the acceleration calculated in the step S13 of the flowchart in FIG. 4.

In the determination made in the step S21, when the rotational speed is not more than 2,000 rpm for example, the determination is made to be idling and “YES” and the phase data which outputs, for example, at the step S24 an idling output current of 4 Amps as retrieved from the ROM 39c.

In the determination made in the step S22, when the acceleration is more than 83 rpm for example, a determination is made to be acceleration and “YES” and the at the step S25 phase data which outputs, for example, an acceleration output current of 2 Amps is retrieved from the ROM 39c.

In the determination made in the step S23, if the deceleration is more than −83 rpm for example, the determination is made to be deceleration and “YES” and at the step S26 the phase data which outputs, for example, an deceleration output current of 8 A is retrieved from the ROM 39c.

If the result at each step S21 to S23 is determined as “NO,” the phase data outputs as the step S27, for example, a constant-speed output current of 6 A is retrieved from the ROM 39c.

After retrieving the phase data, the step returns to the step S13 of the flowchart in FIG. 3 to proceed to the Step S14.

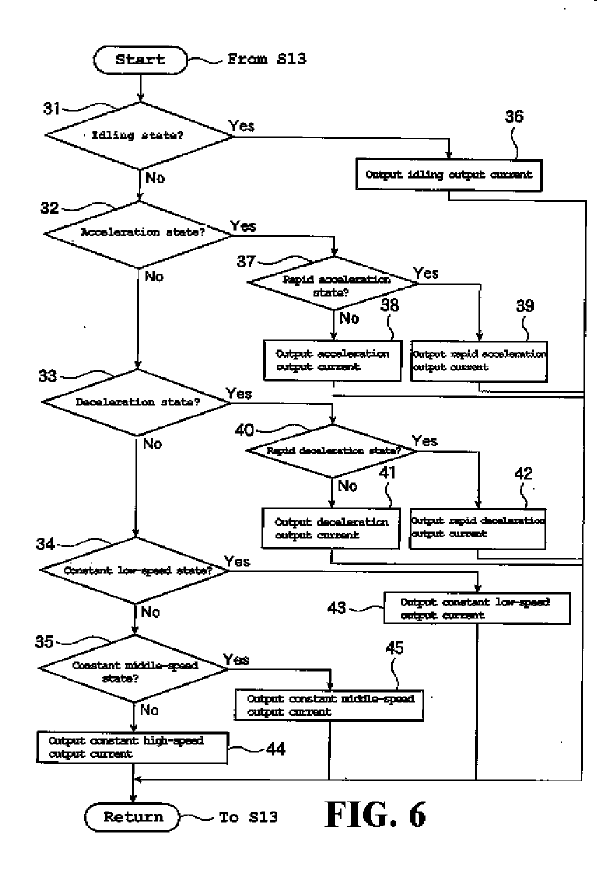

FIG. 6 is a flowchart (subroutine) according to another method for performing the detailed procedure for performing the step S13 of the flowchart shown in FIG. 4.

In accordance with this method, each of determinations, whether the operation mode is idling or not (step S31), whether the operation mode is acceleration or not (step S32), whether the operation mode is deceleration or not (step S33), whether the operation mode is constant low-speed or not (step S34), and whether the operation mode is constant middle-speed or not (step S35) are sequentially made based on the amplitude of the rotational speed and the acceleration calculated in the step S13 of the flowchart in FIG. 3. In addition, the determinations whether the operation mode is rapid acceleration or not (step S37) and whether the operation mode is rapid deceleration or not (step S40) are also made.

If at the step S31 it is determined that the engine is operating at idle, the program moves to the step S36 and outputs the stored idling output current and returns to the step S15 in FIG. 4.

Assuming that the engine 16 is not idling, the program moves to the step S32. If at the step S32 if the acceleration is more than 83 rpm, as an example, the determination is made to be “YES,” the step proceeds to the step S37 and the determination whether the current acceleration is more than 166 rpm or not is further made. If the current acceleration is between 83 rpm and 166 rpm, the phase data which outputs, for example, an acceleration output current of 2 A is retrieved from the ROM 39c at the Step S38).

If at the step S37, the current acceleration is more than 166 rpm (rapid acceleration mode), no phase data is outputted, for example, so that a rapid acceleration output current of zero A is determined at the step S39). The program then returns to the step S13 in FIG.4.

If at the step S32 it is determined that there is no acceleration, the program moves to the step S33 to determine if the engine 16 is decelerating.

In the determination performed in the step S33, when the deceleration is more than −83 rpm as an example, the determination is made to be “YES,” and the program proceeds to the step S40 and the determination whether the current deceleration is more than −166 rpm (rapid deceleration) or not is further made.

If the current deceleration is between −83 rpm and −166 rpm, the phase data which outputs at the step S41 an deceleration output current of, for example, 8 A is retrieved from the ROM 39c (step S41). When the current deceleration is more than −166 rpm in the rapid deceleration mode, the phase data which outputs a rapid deceleration output current of 10 A, for example, retrieved from the ROM 39c at the step S42. Then the program returns to the step S13 in FIG. 4.

Assuming that idling or acceleration or deceleration are not present, at the step S34 and, for example, when the rotational speed is between 2,000 rpm and 3,500 rpm, the determination is made to be constant low-speed and “YES” is determined in the step S34 and the phase data which outputs a constant low-speed output current of, for example, 5 A is retrieved from the ROM 39c and is outputted at the step S43.

On the other hand if none of idling, acceleration, deceleration or constant low speed, the program moves to the step S35 to determine if the rotational speed is between 3,500 rpm and 5,000 rpm, the determination is made to be constant middle-speed and “YES” is determined. Then the program moves to the step S43 and the phase data outputs, for example, a constant middle-speed output current of 3 A from the ROM 39c.

If none of the previous engine running conditions are determined, the program then continues on to detect the actual engine running condition at the step S35. For example, when the rotational speed is more than 5,000 rpm, the determination is made to be constant high-speed and “Yes” in the step S35. Then at the step S45 the phase data which outputs, for example, a constant middle speed output current of 1 A is retrieved from the ROM 39c.

If none of the aforementioned conditions (idling, acceleration, deceleration, constant low, or mid range are detected at the step S44, it is assumed that the engine 16 is operating at constant high speed and the program returns to the step S13 in FIG. 4.

According to the embodiments described above, the phase angle is set to the specific value corresponding to a plurality of operation modes such as start-up, idling, low-speed, middle-speed, high-speed, acceleration, deceleration and so forth, which enables to obtain the amount of generated power required for each operation mode when the operation mode is changed. Thereby, the generated current can be adapted to be a required and appropriate load current corresponding to the operation mode. Accordingly, smooth operation, prevention of over-discharging of the battery and energy-saving operation can be achieved.

According to the embodiments described above, since the phase angle stored in the nonvolatile memory is set to an angle at which zero or a very small amount of power is generated in the start-up operation mode. Therefore, when the magneto 31 coupled to the crankshaft 17 of the internal combustion engine 16 is controlled to generate a small amount of power in the start-up operation mode, the load torque applied on the magneto becomes small which makes the starter motor to rotate the crankshaft easily, thereby facilitating a start-up of the internal combustion engine and reducing failures on start-up.

Also according to the embodiments described above, since the phase angle stored in the nonvolatile memory is set to an angle at which the whole or most of the positive voltage waveform of the generated power of the magneto turns on the gate of the thyristor in the rectifying section in the idling operation mode, generally whole amount of the generated power of the magneto is rectified into the DC current in the idling operation mode which makes the power generation stable even though the rotation period signal is unstable, thereby charging the battery with the generated power and preventing over-discharging of the battery.

Furthermore, with the embodiments described, since the phase angle stored in the nonvolatile memory in the acceleration mode is set to an angle larger than that corresponding to the constant-speed state at the current rotational speed, the load torque applied on the crankshaft becomes small in the acceleration mode which facilitates the crankshaft to rotate smoothly, thereby rapid acceleration can be achieved.

In addition, since the phase angle stored in the nonvolatile memory in the deceleration mode is set to an angle smaller than that corresponding to the constant-speed state at the current rotational speed, the load torque applied on the crankshaft becomes large in the deceleration mode which makes the deceleration efficient, thereby charging the battery with the generated power and preventing over-discharging of the battery.

Also according to the embodiments described above, since the phase angle stored in the nonvolatile memory in the operation mode in which a headlight is lit is set to an angle smaller than that corresponding to the constant-speed state at the current rotational speed, the amount of the generated power of the magneto in the operation mode in which a headlight is lit becomes large, thereby charging the battery with the generated power and preventing over-discharging of the battery.

According to the embodiments described above, since the phase angle stored in the nonvolatile memory in the high-speed constant operation mode is set to an angle smaller than that corresponding to the constant middle-speed or low-speed state, the amount of the generated power of the magneto in the high-speed constant operation mode becomes larger than that in the middle-speed or low-speed constant operation mode, thereby charging the battery with the generated power and preventing over-discharging of the battery.

According to the embodiments described above, since the voltage detection circuit 38 needs not to be provided with a crank angle sensor, an encoder or a sensor which detects the rotation period, arrangement of components becomes simple and costs for sensors and man-hours for assembling can be reduced, thereby achieving cost reduction.

Since the headlight 33a is invariably lit during the night, it is preferable to provide a headlight operation mode to correspond respectively to a plurality of operation modes such as low-speed running, middle-speed running, high-speed running, acceleration, deceleration and the like. It is preferable not to provide the headlight operation mode in start-up and idling in order to make the load torque on the magneto small.

The headlight operation mode is distinguished from the operation mode in which the headlight is not lit by providing a current sensor to detect lighting the headlight (flowed current); a detected signal by the current sensor is inputted to the microcomputer 39; and the microcomputer 39 sets the phase angle small (shorten the output time of the trigger signal) relative to each operation mode when the headlight is not lit.

In the embodiment described above, the regulating section is adapted to calculate the rotational speed and the acceleration based on the voltage signal of the magneto. However, the rotational speed and the acceleration may be calculated based on a signal related to the rotation period of the crankshaft or the magneto.

Obviously those skilled in the art will recognize that the present invention is not limited to the embodiments described above and is capable of various modifications by those skilled in the art without departing from the spirit and the technical scope thereof as set forth in the appended claims.

1. A generator control device comprising a plural phase magneto driven by the crankshaft of an internal combustion engine for generating an AC current, a generated current control for rectifying the generated AC current to a DC current and regulating the amount of generated power to supply the regulated generated current to an electric device, a battery connected to said electric device in parallel with said generated current control, said generated current control including a rectifying section for converting the AC current generated by said magneto to a DC current and a regulating section for regulating the amount of generated power of the rectifying section, said rectifying section being comprised of a plural series-connected sets of a diode and a thyristor equal to the number of phases of said magneto and configured in a plural phase bridging connection, the AC current induced by each stator coil of said magneto being inputted at a mid point of a respective one of said diodes and thyristor, said regulating section including a nonvolatile memory for storing phase data used for the output timing of a trigger signal outputted to a gate of the thyristor corresponding to respective operation modes of the driving internal combustion engine as determined from engine rotational speed and acceleration, means for determining the engine rotational speed and the acceleration based on a signal related to a rotation period of one of said crankshaft and said magneto to determine the operation mode and outputting a trigger signal to the gate of each thyristor based on the phase data.

2. A generator control device as set forth in claim 1 wherein one of the operational modes detected is engine start up and no or only a small amount of electrical power is generated under that condition.

3. A generator control device as set forth in claim 3 wherein start up is determined by the initiation of an output from the generator.

4. A generator control device as set forth in claim 1 wherein one of the operational modes detected is the engine operating at idle.

5. A generator control device as set forth in claim 1 wherein one of the operational modes detected is the engine operating within a predetermined speed range.

6. A generator control device as set forth in claim 1 wherein one of the operational modes detected is the engine accelerating.

7. A generator control device as set forth in claim 1 wherein one of the operational modes detected is the engine decelerating.

8. A generator control device as set forth in claim 1 wherein one of the operational modes detected is a condition where a certain electrical load is being operated.

9. A generator control device as set forth in claim 1 wherein the regulating section includes a phase angle setting device for calculating the rotational speed and the acceleration with an input signal related to a rotation period of the engine, determining the operation mode based on the rotational speed and the acceleration, and for retrieving the phase angle corresponding to the operation mode from the nonvolatile memory to set the phase angle for setting the timing, a count start timing determination device for determining whether or not a voltage value of an inputted voltage signal of the magneto becomes a threshold value for starting calculation of the phase angle, a trigger signal output instructing device for calculating the phase angle after the count start timing determined by the count start timing determination device, determining whether or not the phase angle is equal to the phase angle for setting the timing and for outputting an output instruction signal for the trigger signal when the phase angle is equal to the phase angle for setting the timing; and a trigger signal output device for outputting a trigger signal to the gate of each thyristor in the rectifying section based on the output instruction signal for the trigger signal.

10. A vehicle powered by an internal combustion engine and generator control device as set forth in claim 1 wherein the vehicle has a seat of straddle type on which an operator may be seated, at least one wheel driven by the crankshaft through a transmission with the operator's legs straddling said engine and at least one dirigible wheel.
